(19) United States
(12) Patent Application Publication
(10) Pub. No.: US 2025/0211973 A1
(43) Pub. Date: Jun. 26, 2025

(54) METHOD FOR TRANSMITTING INFORMATION AND USER EQUIPMENT

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/852,253

(22) PCT Filed: Mar. 31, 2022
(86) PCT No.: PCT/CN2022/084606

§ 371 Date: Sep. 27, 2024

(51) Int. Cl. H04W 8/22; H04L 5/00; H04W 24/10; H04W 84/06

(52) U.S. Cl. CPC H04W 8/22; H04L 5/0051; H04W 24/10; H04W 84/06

(57) ABSTRACT

The present disclosure provides a method for transmitting information and a user equipment. In the method, the user equipment sends indication information to a network device. The indication information is used to indicate whether the user equipment supports a capability of simultaneously measuring signals from different satellite networks.

### CROSS-REFERENCE TO RELATED APPLICATIONS

The present application is a U.S. National Stage of International Application No. PCT/CN2022/084606 filed on Mar. 31, 2022, the entire contents of which are incorporated herein by reference for all purposes.

### TECHNICAL FIELD

The present disclosure relates to the field of wireless communication technology, and in particular, to a method and device for transmitting information, an apparatus and a storage medium.

### BACKGROUND

In a non-terrestrial network (NTN) system, different cells may be covered by satellites in different orbits, such as geo-stationary satellites (GSOs) and non-geo-stationary satellites (NGSOs). When a user equipment performs a neighbouring cell measurement, the user equipment may not have a capability of supporting the simultaneous reception of signals from satellites in different orbits as different orbital satellites correspond to a servicing cell and a neighbouring cell.

### SUMMARY

The present disclosure provides a method and device for transmitting information, an apparatus, and a storage medium.

A first aspect of embodiments of the present disclosure provides a method for transmitting information, performed by a user equipment, including:
sending indication information to a network device, the indication information being configured to indicate whether the user equipment supports a capability of simultaneously measuring signals from different satellite networks.

In an implementation, the method further includes:
in response to the indication information indicating that the user equipment supports the capability of simultaneously measuring the signals from the different satellite networks, performing, by the user equipment, user equipment scheduling within a servicing cell during a neighbouring cell measurement performed by the user equipment,
wherein the servicing cell corresponds to a first satellite network, the neighbouring cell corresponds to a second satellite network, and the first satellite network is different from the second satellite network.

In an implementation, the method further includes:
in response to the indication information indicating that the user equipment does not support the capability of simultaneously measuring the signals from the different satellite networks, stopping, by the user equipment, user equipment scheduling within a servicing cell for a set time period,
wherein the servicing cell corresponds to a first satellite network, the neighbouring cell corresponds to a second satellite network, and the first satellite network is different from the second satellite network, and
wherein the set time period is a sum of a time period for the user equipment performing the neighbouring cell measurement and an additional time period.

In an implementation, the user equipment scheduling includes at least one of receiving and/or sending a data control service;
measuring a downlink reference signal;
sending an uplink reference signal; and
performing a layer 1 measurement.

In an implementation, simultaneously measuring the signals from the different satellite networks includes an intra-frequency measurement of the signals from the different satellite networks and an inter-frequency measurement of the signals from the different satellite networks.

In an implementation, the inter-frequency measurement is an inter-frequency measurement without a measurement gap.

In an implementation, the different satellite networks include at least one of a geo-stationary satellite network and a non-geo-stationary satellite network.

A second aspect of embodiments of the present disclosure provides a method for transmitting information, performed by a network device, including:
receiving indication information from a user equipment, the indication information being configured to indicate whether the user equipment supports a capability of simultaneously measuring signals from different satellite networks.

In an implementation, the method further includes:
in response to the indication information indicating that the user equipment supports the capability of simultaneously measuring the signals from the different satellite networks, performing, by the network device, network device scheduling within a servicing cell of the user equipment during a neighbouring cell measurement performed by the user equipment,
wherein the servicing cell corresponds to a first satellite network, the neighbouring cell corresponds to a second satellite network, and the first satellite network is different from the second satellite network.

In an implementation, the method further includes:
in response to the indication information indicating that the user equipment does not support the capability of simultaneously measuring the signals from the different satellite networks, stopping, by the network device, network device scheduling within a servicing cell of the user equipment for a set time period,
wherein the servicing cell corresponds to a first satellite network, the neighbouring cell corresponds to a second satellite network, and the first satellite network is different from the second satellite network, and
wherein the set time period is a sum of a time period for the user equipment performing the neighbouring cell measurement and an additional time period.

In an implementation, the network device scheduling includes at least one of:
receiving and/or sending a data control service;
receiving an uplink reference signal; and
sending a downlink reference signal.

In an implementation, simultaneously measuring the signals from the different satellite networks includes an intra-frequency measurement of the signals from the different satellite networks and an inter-frequency measurement of the signals from the different satellite networks.

In an implementation, the inter-frequency measurement is an inter-frequency measurement without a measurement gap.

In an implementation, the different satellite networks include at least one of a geo-stationary satellite network and a non-geo-stationary satellite network.

A third aspect of embodiments of the present disclosure provides a device for transmitting information, provided in a user equipment, including:

a communication module, configured to send indication information to a network device, the indication information being configured to indicate whether the user equipment supports a capability of simultaneously measuring signals from different satellite networks.

A fourth aspect of embodiments of the present disclosure provides a device for transmitting information, provided in a network device, including:
a communication module, configured to receive indication information from a user equipment, the indication information being configured to indicate whether the user equipment supports a capability of simultaneously measuring signals from different satellite networks.

A fifth aspect of embodiments of the present disclosure provides a mobile terminal, including:
a processor; and
a memory for storing instructions executable by the processor,
wherein the processor is configured to execute instructions in the memory to implement steps in the method for transmitting information described above.

A sixth aspect of embodiments of the present disclosure provides a network device, including:
a processor; and
a memory for storing instructions executable by the processor,
wherein the processor is configured to execute instructions in the memory to implement steps in the method for transmitting information described above.

A seventh aspect of embodiments of the present disclosure provides a non-transitory computer-readable storage medium having executable instructions stored thereon that when being executed by a processor, cause the processor to implement steps in the method for transmitting information described above.

It should be understood that the above general description and the detailed description that follows are exemplary and explanatory only and do not limit the present disclosure.

### BRIEF DESCRIPTION OF THE DRAWINGS

The accompanying drawings illustrated herein are used to provide a further understanding of the embodiments of the present disclosure and form a part of the present disclosure, and the schematic embodiments of the present disclosure and illustrations thereof are used to explain the embodiments of the present disclosure and do not constitute an undue limitation of the embodiments of the present disclosure.

The accompanying drawings herein, which are incorporated into and form a part of the specification, illustrate embodiments that conform to the embodiments of the present disclosure and are used in conjunction with the specification to explain the principle of the embodiments of the present disclosure.

FIG. 1 is a schematic diagram of an NTN system in which different cells are covered by satellites in different orbits;

FIG. 2 is a flowchart of a method for transmitting information according to an embodiment;

FIG. 3 is a flowchart of a method for transmitting information according to an embodiment;

FIG. 4 is a flowchart of a method for transmitting information according to an embodiment;

FIG. 5 is a flowchart of a method for transmitting information according to an embodiment;

FIG. 6 is a flowchart of a method for transmitting information according to an embodiment;

FIG. 7 is a flowchart of a method for transmitting information according to an embodiment;

FIG. 8 is a block diagram of a device for transmitting information according to an embodiment;

FIG. 9 is a block diagram of a device for transmitting information according to an embodiment;

FIG. 10 is a structural diagram of a device for transmitting information according to an embodiment; and

FIG. 11 is a structural diagram of a device for transmitting information according to an embodiment.

### DETAILED DESCRIPTION

Embodiments of the present disclosure are further described in connection with the accompanying drawings and specific implementations.

Embodiments will be described herein in detail, examples of which are represented in the accompanying drawings. When the following description relates to the accompanying drawings, the same reference numeral in different accompanying drawings indicate the same or similar element unless otherwise indicated. The implementations described in the following embodiments do not represent all implementations consistent with the embodiments of the present disclosure. Rather, they are only examples of devices and methods consistent with some aspects of the present disclosure as detailed in the appended claims.

It is to be noted that a plurality of steps may be included in an embodiment of the present disclosure, and these steps are numbered for easy description. However, these numbers are not a limitation on an execution time gap between steps or an order in which the steps are performed, and the steps may be performed in any order, which is not limited in the embodiments of the present disclosure.

In the description of the present disclosure, terms such as “first”, “second”, “third”, etc., are used only for distinction, and are not to be construed as indicating or implying relative importance, or as indicating or implying an order. The term “a plurality of . . . ” means two or more.

The term “and/or” describes an association of associated objects, and indicates that there may be three relationships, e.g., A and/or B may indicate A alone, both A and B, and B alone.

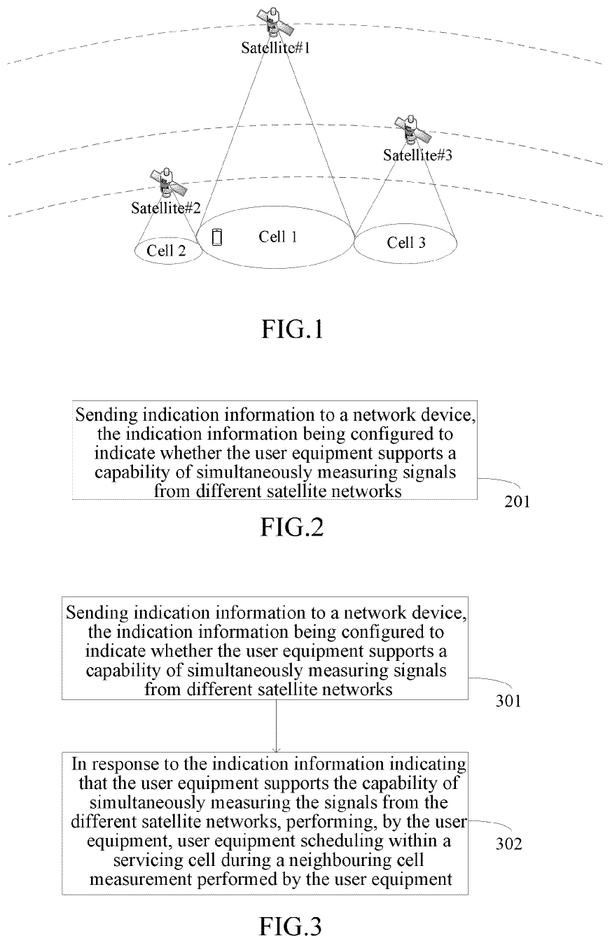

FIG. 1 illustrates a schematic diagram of an NTN system in which different cells are covered by satellites in different orbits. For example, the Satellite #1 is a GSO, and the Satellite #2 and Satellite #3 are NGSOs. The Cell 1 is a servicing cell of a user equipment, and the Cell 2 and Cell 3 are neighbouring cells of the user equipment. When the user equipment performs a neighbouring cell measurement, the user equipment may not have a capability of supporting the simultaneous reception of signals from satellites in different orbits as different orbital satellites correspond to the servicing cell and the neighbouring cell.

An embodiment of the present disclosure provides a method for transmitting information, which is performed by a user equipment. FIG. 2 is a flowchart of a method for transmitting information according to an embodiment, and as illustrated in FIG. 2, the method includes:
step 201, sending indication information to a network device, the indication information being configured to indicate whether the user equipment supports a capability of simultaneously measuring signals from different satellite networks.

In an implementation, the user equipment sends the indication information to the network device for example via radio resource control (RRC) signaling, and the indication information is configured to indicate whether the user equipment supports a capability of simultaneously measuring signals from different satellite networks. For example, the user equipment sends the indication information to the network device via RRC signaling such as IEMeasAndMobParameters or IEMeasAndMobParametersMRDC.

In an implementation, the satellite network corresponding to the servicing cell of the user equipment is different from the satellite network corresponding to the neighbouring cell. The user equipment sends, via RRC signaling, the indication information to the network device, and the indication information is configured to indicate whether the user equipment supports the capability of simultaneously measuring signals from different satellite networks.

For example, the capability of simultaneously measuring the signals from different satellite networks refers to the capability of the user equipment for simultaneously measuring a signal from an other satellite that is different from the satellite corresponding to the servicing cell without affecting an normal operation of the user equipment in the servicing cell. The normal operation of the user equipment in the servicing cell here includes receiving and sending a data control service, for example receiving and sending a synchronization signal block (SSB), a sounding reference signal (SRS), a channel state information-reference signal (CSI-RS) and other reference signals.

In the above implementation, the user equipment reports to the network device whether the user equipment supports the capability of simultaneously measuring signals from different satellite networks, so that the user equipment may employ different scheduling schemes during a neighbouring cell measurement, without additional consideration of scheduling limitation requirements.

An embodiment of the present disclosure provides a method for transmitting information, which is performed by a user equipment. FIG. 3 is a flowchart of a method for transmitting information according to an embodiment, and as illustrated in FIG. 3, the method includes:
step 301, sending indication information to a network device, the indication information being configured to indicate whether the user equipment supports a capability of simultaneously measuring signals from different satellite networks; and
step 302, in response to the indication information indicating that the user equipment supports the capability of simultaneously measuring the signals from the different satellite networks, performing, by the user equipment, user equipment scheduling within a servicing cell during a neighbouring cell measurement performed by the user equipment.

The servicing cell corresponds to a first satellite network, the neighbouring cell corresponds to a second satellite network, and the first satellite network is different from the second satellite network.

In an implementation, the satellite network corresponding to the servicing cell of the user equipment is different from the satellite network corresponding to the neighbouring cell. The user equipment sends, for example via RRC signaling, the indication information to the network device, and the indication information is configured to indicate whether the user equipment supports the capability of simultaneously measuring the signals from different satellite networks. If the user equipment supports the capability of simultaneously measuring the signals from different satellite networks, the user equipment simultaneously performs normal user equipment scheduling within the serving cell during a neighbouring cell measurement performed by the user equipment. That is, the user equipment simultaneously measures the signals from different satellite networks.

In an implementation, the user equipment scheduling refers to normal scheduling performed by the user equipment, and includes at least one of receiving and/or sending a data control service, measuring a downlink reference signal, sending an uplink reference signal and performing a layer 1 (L1) measurement.

For example, the downlink reference signal includes SSB, CSI-RS, the uplink reference signal includes SRS, the L1 measurement includes radio link monitoring (RLM), candidate beam detection (CBD), beam failure detection (BFD), Layer 1-reference signal receiving power (L1-RSRP).

In the above implementation, the user equipment reports to the network device whether the user equipment supports a capability of simultaneously measuring signals from different satellite networks, and performs normal scheduling within a serving cell during a neighbouring cell measurement when supporting the capability of simultaneously measuring the signals from different satellite networks, which does not need to additionally consider scheduling limitation requirements. Therefore, the user equipment may adopt a suitable scheduling strategy according to the capability thereof.

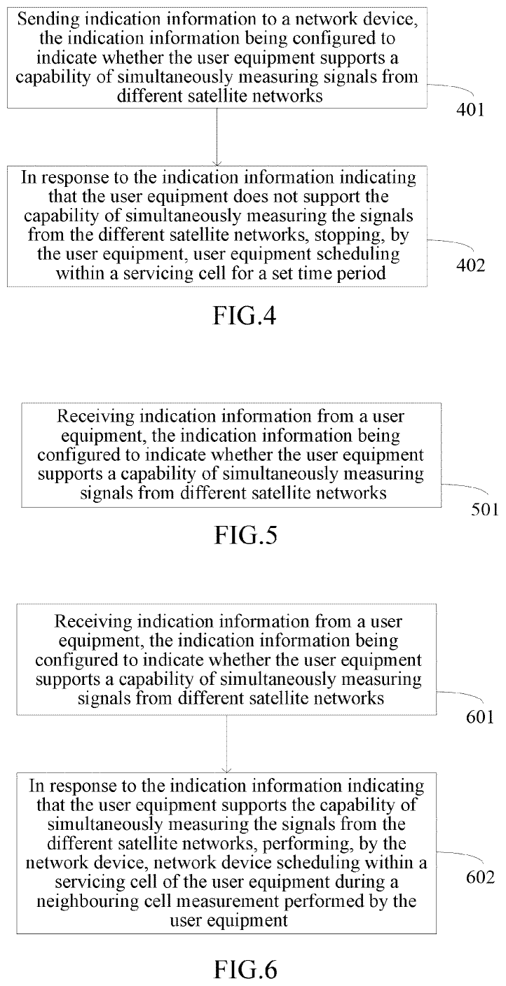

An embodiment of the present disclosure provides a method for transmitting information, which is performed by a user equipment. FIG. 4 is a flowchart of a method for transmitting information according to an embodiment, and as illustrated in FIG. 4, the method includes:
step 401, sending indication information to a network device, the indication information being configured to indicate whether the user equipment supports a capability of simultaneously measuring signals from different satellite networks; and
step 402, in response to the indication information indicating that the user equipment does not support the capability of simultaneously measuring the signals from the different satellite networks, stopping, by the user equipment, user equipment scheduling within a servicing cell for a set time period.

The servicing cell corresponds to a first satellite network, the neighbouring cell corresponds to a second satellite network, and the first satellite network is different from the second satellite network. The set time period is a sum of a time period for the user equipment performing the neighbouring cell measurement and an additional time period.

In an implementation, the satellite network corresponding to the servicing cell of the user equipment is different from the satellite network corresponding to the neighbouring cell. The user equipment sends, for example via RRC signaling, the indication information to the network device, and the indication information is configured to indicate whether the user equipment supports the capability of simultaneously measuring the signals from different satellite networks. If the user equipment does not support the capability of simultaneously measuring the signals from different satellite networks, the user equipment does not perform normal user equipment scheduling within the serving cell for a set time period including a neighbouring cell measurement period. That is, the user equipment does not simultaneously measure the signals from different satellite networks.

For example, the time period during which the user equipment performs the neighbour cell measurement is agreed by a communication protocol. For example, the time period for the neighbour cell measurement is agreed to be 5 ms. The set time period is a sum of the time period for the neighbour cell measurement and an additional time period.

In an implementation, the user equipment scheduling refers to normal scheduling performed by the user equipment and includes at least one of: receiving and/or sending a data control service; measuring a downlink reference signal; sending an uplink reference signal; and performing an L1 measurement.

For example, the downlink reference signal includes SSB and CSI-RS, the uplink reference signal includes SRS, and the L1 measurement includes RLM, CBD, BFD and L1-RSRP.

In the above implementation, the user equipment reports to the network device whether the user equipment supports a capability of simultaneously measuring signals from different satellite networks, and does not perform normal scheduling within a serving cell during a neighbouring cell measurement when not supporting the capability of simultaneously measuring the signals from different satellite networks, which does not need to additionally consider scheduling limitation requirements. Therefore, the user equipment may adopt a suitable scheduling strategy according to the capability thereof.

An embodiment of the present disclosure provides a method for transmitting information, performed by a user equipment, and including:
sending indication information to a network device, the indication information being configured to indicate whether the user equipment supports a capability of simultaneously measuring signals from different satellite networks, and simultaneously measuring the signals from the different satellite networks including an intra-frequency measurement of the signals from the different satellite networks and an inter-frequency measurement of the signals from the different satellite networks.

In an implementation, the user equipment sends, for example via RRC signaling, the indication information to the network device, and the indication information is configured to indicate whether the user equipment supports the capability of simultaneously measuring the signals from different satellite networks. Here, simultaneously measuring the signals from the different satellite networks includes an intra-frequency measurement of the signals from the different satellite networks and an inter-frequency measurement of the signals from the different satellite networks.

The intra-frequency measurement means that both the serving cell and the neighbouring cell are on a same center frequency point. The inter-frequency measurement means that the serving cell and the neighbouring cell are not on the same center frequency point.

In an implementation, the inter-frequency measurement is an inter-frequency measurement without a measurement gap (GAP), i.e., the user equipment does not require the measurement gap during the inter-frequency measurement of the signals from the different satellite networks.

For example, the user equipment reports a capability of not requiring an inter-frequency measurement gap (interFrequencyConfig-NoGap-r16) to the network device, and the network device configures an interFrequencyConfig-NoGap-r16 indication instruction and sends the instruction to the user equipment to indicate on which frequencies the user equipment does not require a measurement gap when performing the inter-frequency measurement.

It is to be noted that the measurement gap means reserving a portion of time (i.e., measurement GAP time) when performing the inter-frequency measurement, during which the UE does not send and receive any data, but tunes the receiver to a target cell frequency point to perform the inter-frequency measurement, and then switches to the current cell when the GAP time expires.

In the above implementation, the user equipment reports to the network device whether the user equipment supports the capability of simultaneously measuring signals from different satellite networks, so that the user equipment may employ different scheduling schemes during a neighbouring cell measurement, without additional consideration of scheduling limitation requirements.

An embodiment of the present disclosure provides a method for transmitting information, performed by a user equipment and including:
sending indication information to a network device, the indication information being configured to indicate whether the user equipment supports a capability of simultaneously measuring signals from different satellite networks, and the different satellite networks including at least one of a geo-stationary satellite network and a non-geo-stationary satellite network.

In an implementation, the user equipment sends, for example via RRC signaling, the indication information to the network device, and the indication information is configured to indicate whether the user equipment supports the capability of simultaneously measuring the signals from different satellite networks. Here, the different satellite networks include at least one of a geo-stationary satellite network and a non-geo-stationary satellite network.

In an implementation, the satellite networks corresponding to the servicing cell of the user equipment and the neighbouring cell are different, which are a GSO network and a NGSO network, respectively. The user equipment sends, via RRC signaling, the indication information to the network device, and the indication information is configured to indicate whether the user equipment supports the capability of simultaneously measuring the signals from different satellite networks.

In an implementation, the satellite networks corresponding to the servicing cell of the user equipment and the neighbouring cell are different, which both are GSO networks. The user equipment sends, via RRC signaling, the indication information to the network device, and the indication information is configured to indicate whether the user equipment supports the capability of simultaneously measuring the signals from different satellite networks.

In an implementation, the satellite networks corresponding to the servicing cell of the user equipment and the neighbouring cell are different, which both are NGSO networks. The user equipment sends, via RRC signaling, the indication information to the network device, and the indication information is configured to indicate whether the user equipment supports the capability of simultaneously measuring the signals from different satellite networks.

In the above implementation, the user equipment reports to the network device whether the user equipment supports the capability of simultaneously measuring signals from different satellite networks, so that the user equipment may employ different scheduling schemes during a neighbouring cell measurement, without additional consideration of scheduling limitation requirements.

An embodiment of the present disclosure provides a method for transmitting information, which is performed by a network device. FIG. 5 is a flowchart of a method for transmitting information according to an embodiment, and as illustrated in FIG. 5, the method includes:
step 501, receiving indication information from a user equipment, the indication information being configured to indicate whether the user equipment supports a capability of simultaneously measuring signals from different satellite networks.

In an implementation, the network device receives the indication information sent by the user equipment for example via RRC signaling, and the indication information is configured to indicate whether the user equipment supports a capability of simultaneously measuring signals from different satellite networks. For example, the network device receives the indication information sent by the user equipment via RRC signaling such as IEMeasAndMobParameters or IEMeas AndMobParametersMRDC.

For example, the capability of simultaneously measuring the signals from different satellite networks refers to the capability of the user equipment for simultaneously measuring a signal from an other satellite that is different from the satellite corresponding to the servicing cell without affecting an normal operation of the user equipment in the servicing cell. The normal operation of the user equipment in the servicing cell here includes receiving and sending a data control service, for example receiving and sending SSB, SRS, CSI-RS and other reference signals.

In the above implementation, the network device receives information regarding whether the user equipment supports the capability of simultaneously measuring signals from different satellite networks, which is reported by the user equipment, so that the network device may employ different scheduling schemes during a neighbouring cell measurement of the user equipment, without additional consideration of scheduling limitation requirements.

An embodiment of the present disclosure provides a method for transmitting information, which is performed by a network device. FIG. 6 is a flowchart of a method for transmitting information according to an embodiment, and as illustrated in FIG. 6, the method includes:
step 601, receiving indication information from a user equipment, the indication information being configured to indicate whether the user equipment supports a capability of simultaneously measuring signals from different satellite networks; and
step 602, in response to the indication information indicating that the user equipment supports the capability of simultaneously measuring the signals from the different satellite networks, performing, by the network device, network device scheduling within a servicing cell of the user equipment during a neighbouring cell measurement performed by the user equipment.

The servicing cell corresponds to a first satellite network, the neighbouring cell corresponds to a second satellite network, and the first satellite network is different from the second satellite network.

In an implementation, the satellite network corresponding to the servicing cell of the user equipment is different from the satellite network corresponding to the neighbouring cell. The network device receives the indication information sent by the user equipment for example via RRC signaling, and the indication information is configured to indicate whether the user equipment supports the capability of simultaneously measuring the signals from different satellite networks. If the network device determines, via the indication information reported by the user equipment, that the user equipment supports the capability of simultaneously measuring the signals from different satellite networks, the network device simultaneously performs normal network scheduling within the serving cell of the user equipment during a neighbouring cell measurement performed by the user equipment.

In an implementation, the network device scheduling refers to normal scheduling performed by the network device within the serving cell of the user equipment, and includes at least one of receiving and/or sending a data control service; receiving an uplink reference signal; and sending a downlink reference signal.

For example, the uplink reference signal includes SRS, and the downlink reference signal includes SSB and CSI-RS.

In the above implementation, the network device receives information regarding whether the user equipment supports the capability of simultaneously measuring signals from different satellite networks, which is reported by the user equipment, and performs normal scheduling within a serving cell of the user equipment during a neighbouring cell measurement performed by the user equipment when the user equipment supports the capability of simultaneously measuring the signals from different satellite networks, which does not need to additionally consider scheduling limitation requirements. Therefore, the network device may adopt different scheduling solutions during the neighbouring cell measurement performed by the user equipment.

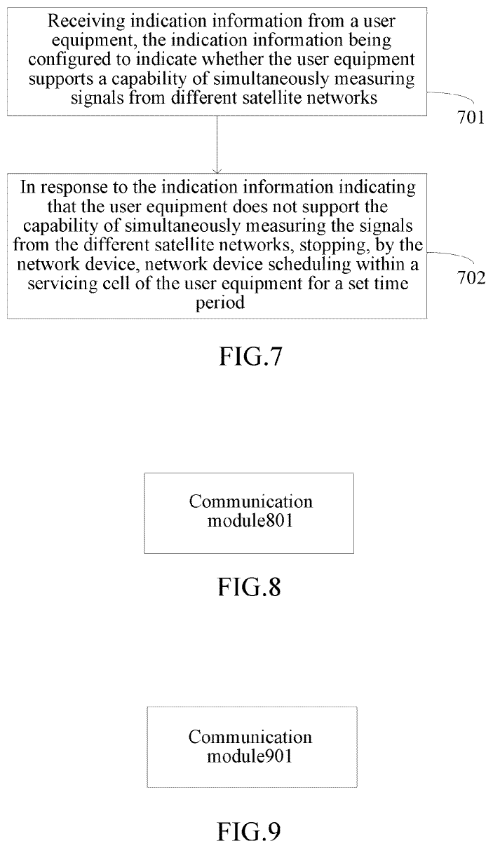

An embodiment of the present disclosure provides a method for transmitting information, which is performed by a network device. FIG. 7 is a flowchart of a method for transmitting information according to an embodiment, and as illustrated in FIG. 7, the method includes:
step 701, receiving indication information from a user equipment, the indication information being configured to indicate whether the user equipment supports a capability of simultaneously measuring signals from different satellite networks; and
step 702, in response to the indication information indicating that the user equipment does not support the capability of simultaneously measuring the signals from the different satellite networks, stopping, by the network device, network device scheduling within a servicing cell of the user equipment for a set time period.

The servicing cell corresponds to a first satellite network, the neighbouring cell corresponds to a second satellite network, and the first satellite network is different from the second satellite network. The set time period is a sum of a time period for the user equipment performing the neighbouring cell measurement and an additional time period.

In an implementation, the satellite network corresponding to the servicing cell of the user equipment is different from the satellite network corresponding to the neighbouring cell. The network device receives the indication information sent by the user equipment for example via RRC signaling, and the indication information is configured to indicate whether the user equipment supports the capability of simultaneously measuring the signals from different satellite networks. If the network device determines, via the indication information reported by the user equipment, that the user equipment does not support the capability of simultaneously measuring the signals from different satellite networks, the network device does not perform normal network scheduling within the serving cell of the user equipment for a set time period including a neighbouring cell measurement period of the user equipment.

For example, the time period during which the user equipment performs the neighbour cell measurement is agreed by a communication protocol. For example, the time period for the neighbour cell measurement is agreed to be 5 ms. The set time period is a sum of the time period for the neighbour cell measurement and an additional time period.

In an implementation, the network device scheduling refers to normal scheduling performed by the network device within the serving cell of the user equipment, and includes at least one of receiving and/or sending a data control service; receiving an uplink reference signal; and sending a downlink reference signal.

For example, the uplink reference signal includes SRS, and the downlink reference signal includes SSB and CSI-RS.

In the above implementation, the network device receives information regarding whether the user equipment supports the capability of simultaneously measuring signals from different satellite networks, which is reported by the user equipment, and does not perform normal network scheduling within the serving cell of the user equipment during the neighbouring cell measurement of the user equipment when the user equipment does not support the capability of simultaneously measuring the signals from different satellite networks, which does not need to additionally consider scheduling limitation requirements. Therefore, the network device may adopt different scheduling solutions during the neighbouring cell measurement performed by the user equipment.

An embodiment of the present disclosure provides a method for transmitting information, which is performed by a network device, and includes:
receiving indication information from a user equipment, the indication information being configured to indicate whether the user equipment supports a capability of simultaneously measuring signals from different satellite networks, and simultaneously measuring the signals from the different satellite networks including an intra-frequency measurement of the signals from the different satellite networks and an inter-frequency measurement of the signals from the different satellite networks.

In an implementation, the network device receives the indication information sent by the user equipment for example via RRC signaling, and the indication information is configured to indicate whether the user equipment supports the capability of simultaneously measuring the signals from different satellite networks. Here, simultaneously measuring the signals from the different satellite networks includes an intra-frequency measurement of the signals from the different satellite networks and an inter-frequency measurement of the signals from the different satellite networks.

In an implementation, the inter-frequency measurement is an inter-frequency measurement without a measurement gap (GAP), i.e., the user equipment does not require the measurement gap during the inter-frequency measurement of the signals from the different satellite networks.

For example, after receiving a capability of not requiring an inter-frequency measurement gap (interFrequencyConfig-NoGap-r16) reported by the user equipment, the network device configures an interFrequencyConfig-NoGap-r16 indication instruction and sends the instruction to the user equipment to indicate on which frequencies the user equipment does not require a measurement gap when performing the inter-frequency measurement.

In the above implementation, the network device receives information regarding whether the user equipment supports the capability of simultaneously measuring signals from different satellite networks, which is reported by the user equipment, so that the network device may employ different scheduling schemes during a neighbouring cell measurement of the user equipment, without additional consideration of scheduling limitation requirements.

An embodiment of the present disclosure provides a method for transmitting information, which is performed by a network device, and includes:
receiving indication information from a user equipment, the indication information being configured to indicate whether the user equipment supports a capability of simultaneously measuring signals from different satellite networks, and the different satellite networks including at least one of a geo-stationary satellite network and a non-geo-stationary satellite network.

In an implementation, the network device receives the indication information sent by the user equipment for example via RRC signaling, and the indication information is configured to indicate whether the user equipment supports the capability of simultaneously measuring the signals from different satellite networks. Here, the different satellite networks include at least one of a geo-stationary satellite network and a non-geo-stationary satellite network.

For example, the satellite networks corresponding to the servicing cell of the user equipment and the neighbouring cell are different, which are a GSO network and a NGSO network, respectively. For another example, the satellite networks corresponding to the servicing cell of the user equipment and the neighbouring cell are different, which both are GSO networks. For yet another example, the satellite networks corresponding to the servicing cell of the user equipment and the neighbouring cell are different, which both are NGSO networks.

In the above implementation, the network device receives information regarding whether the user equipment supports the capability of simultaneously measuring signals from different satellite networks, which is reported by the user equipment, so that the network device may employ different scheduling schemes during a neighbouring cell measurement of the user equipment, without additional consideration of scheduling limitation requirements.

An embodiment of the present disclosure provides a device for transmitting information, which is provided in a user equipment. As shown in FIG. 8, the device includes:
a communication module 801, configured to send indication information to a network device, the indication information being configured to indicate whether the user equipment supports a capability of simultaneously measuring signals from different satellite networks.

An embodiment of the present disclosure provides a device for transmitting information, which is provided in a user equipment. As shown in FIG. 9, the device includes:
a communication module 901, configured to receive indication information from a user equipment, the indication information being configured to indicate whether the user equipment supports a capability of simultaneously measuring signals from different satellite networks.

An embodiment of the present disclosure provides a mobile terminal, including:
a processor; and
a memory for storing instructions executable by the processor,
wherein the processor is configured to execute instructions in the memory to implement steps in the method for transmitting information described above.

An embodiment of the present disclosure provides a network device, including:
a processor; and
a memory for storing instructions executable by the processor,
wherein the processor is configured to execute instructions in the memory to implement steps in the method for transmitting information described above.

An embodiment of the present disclosure provides a non-transitory computer-readable storage medium having executable instructions stored thereon that when being executed by a processor, cause the processor to implement steps in the method for transmitting information described above.

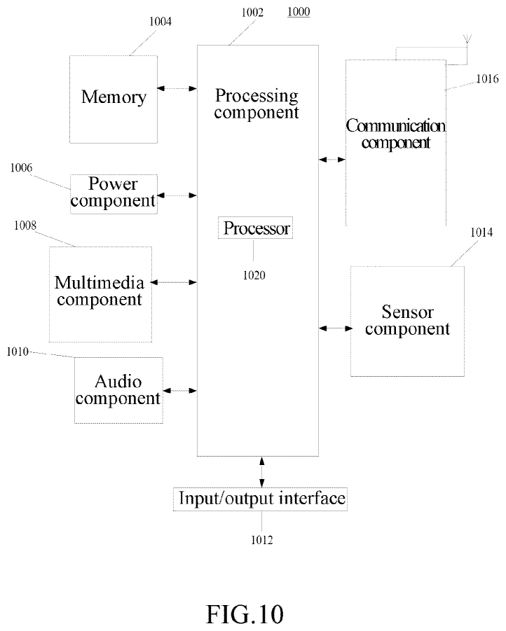

FIG. 10 is a block diagram of a device 1000 for transmitting information according to an embodiment. For example, the device 1000 may be a mobile phone, a computer, a digital broadcasting terminal, a messaging device, a game console, a tablet device, a medical device, a fitness device, a personal digital assistant, or the like.

Referring to FIG. 10, the device 1000 may include one or more of a processing component 1002, a memory 1004, a power component 1006, a multimedia component 1008, an audio component 1010, an input/output (I/O) interface 1012, a sensor component 1014, and a communication component 1016.

The processing component 1002 generally controls the overall operations of the device 1000, such as operations associated with display, telephone calls, data communications, camera operations, and recording operations. The processing component 1002 may include one or more processors 1020 to execute instructions to complete all or part of the steps of the foregoing method. In addition, the processing component 1002 may include one or more modules to facilitate interaction between the processing component 1002 and other components. For example, the processing component 1002 may include a multimedia module to facilitate the interaction between the multimedia component 1008 and the processing component 1002.

The memory 1004 is configured to store various types of data to support the operation of the device 1000. Examples of these data include instructions for any application or method operating on the device 1000, contact data, phone book data, messages, pictures, videos and the like. The memory 1004 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 1006 provides power to various components of the device 1000. The power component 1006 may include a power management system, one or more power supplies, and other components associated with generating, managing, and distributing power for the device 1000.

The multimedia component 1008 includes a screen that provides an output interface between the device 1000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 1008 includes a front camera and/or a rear camera. When the device 1000 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 1010 is configured to output and/or be input audio signals. For example, the audio component 1010 includes a microphone (MIC), and when the device 1000 is in an operation mode, such as a call mode, a recording mode, and a voice recognition mode, the microphone is configured to receive an external audio signal. The received audio signal can be further stored in the memory 1004 or sent via the communication component 1016. In some embodiments, the audio component 1010 further includes a speaker for outputting audio signals.

The I/O interface 1012 provides an interface between the processing component 1002 and a peripheral interface module. The above-mentioned peripheral interface module may be a keyboard, a click wheel, a button, and the like. These buttons may include but are not limited to home button, volume button, start button, and lock button.

The sensor component 1014 includes one or more sensors for providing the device 1000 with various aspects of state evaluation. For example, the sensor component 1014 can detect the on/off status of the device 1000 and the relative positioning of components. For example, the component is a display and keypad of the device 1000. The sensor component 1014 can also detect the position change of the device 1000 or a component of the device 1000, the presence or absence of contact between the user and the device 1000, the orientation or acceleration/deceleration of the device 1000, and the temperature change of the device 1000. The sensor component 1014 may include a proximity sensor configured to detect the presence of nearby objects when there is no physical contact. The sensor component 1014 may also include a light sensor, such as a CMOS or CCD image sensor, for use in imaging applications. In some embodiments, the sensor component 1014 may also include an acceleration sensor, a gyroscope sensor, a magnetic sensor, a pressure sensor, or a temperature sensor.

The communication component 1016 is configured to facilitate wired or wireless communication between the device 1000 and other devices. The device 1000 can access a wireless network based on a communication standard, such as WiFi, 2G, 3G, 4G, 5G, or a combination thereof. In an embodiment, the communication component 1016 receives a broadcast signal or broadcast related information from an external broadcast management system via a broadcast channel. In an embodiment, the communication component 1016 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 1000 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 1004 including instructions, and the instructions may be executed by the processor 1020 of the device 1000 to complete the foregoing method. For example, the non-transitory computer-readable storage medium may be ROM, random access memory (RAM), CD-ROM, magnetic tape, floppy disk, optical data storage device and the like.

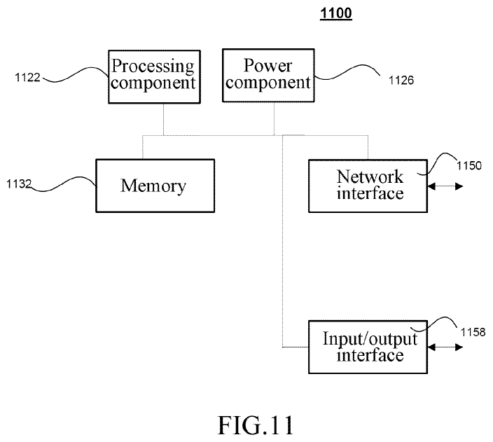

FIG. 11 is a block diagram of a device 1100 for transmitting according to an embodiment. For example, the device 1100 may be provided as a server. Referring to FIG. 11, the device 1100 includes a processing component 1122 which further includes one or more processors, and a memory resource which is represented by a memory 1132 and is configured for storing instructions such as application programs executable by the processing component 1122. The application program stored in the memory 1132 may include one or more modules each corresponding to a set of instructions. Furthermore, the processing component 1122 is configured to execute instructions to perform the above method.

The device 1100 may also include a power component 1126 configured to perform power management of the device 1100, a wired or wireless network interface 1150 configured to connect the device 1100 to a network, and an input/output (I/O) interface 1158. The device 1100 may operate based on an operating system stored in memory 1132, such as Windows Server™ a Mac OS X™, Unix™, Linux™, Free BSD™ or the like.

A person skilled in the art may easily conceive of other embodiments of the present disclosure upon consideration of the specification and practice of the invention disclosed herein. The present disclosure is intended to cover any variations, uses, or adaptations of the present disclosure that follow the general principles of the present disclosure and include the common general knowledge or conventional technical means in the technical field not disclosed by the present disclosure. The specification and embodiments are to be regarded as exemplary only, and the true scope and spirit of the embodiments of the present disclosure are indicated by the following claims.

It is to be understood that the embodiments of the present disclosure are not limited to the precise structures described above and illustrated in the accompanying drawings, and that various modifications and changes may be made without departing from the scope thereof. The scope of the present disclosure is limited only by the appended claims.

### INDUSTRIAL UTILITY

A user equipment reports to a network device whether the user equipment supports a capability of simultaneously measuring signals from different satellite networks, so that the user equipment may employ different scheduling schemes during a neighbouring cell measurement, and the network device may also employ different scheduling schemes during the neighbouring cell measurement of the user equipment, without additional consideration of scheduling limitation requirements.

1. A method for transmitting information, performed by a user equipment, comprising:
sending indication information to a network device, the indication information being configured to indicate whether the user equipment supports a capability of simultaneously measuring signals from different satellite networks.

2. The method according to claim 1, further comprising:
in response to the indication information indicating that the user equipment supports the capability of simultaneously measuring the signals from the different satellite networks, performing user equipment scheduling within a servicing cell during a neighbouring cell measurement performed by the user equipment,
wherein the servicing cell corresponds to a first satellite network, the neighbouring cell corresponds to a second satellite network, and the first satellite network is different from the second satellite network.

3. The method according to claim 1, further comprising:
in response to the indication information indicating that the user equipment does not support the capability of simultaneously measuring the signals from the different satellite networks, stopping user equipment scheduling within a servicing cell for a set time period,
wherein the servicing cell corresponds to a first satellite network, the neighbouring cell corresponds to a second satellite network, and the first satellite network is different from the second satellite network, and
wherein the set time period comprises a time period for the user equipment performing the neighbouring cell measurement.

4. The method according to claim 2, wherein the user equipment scheduling comprises at least one of
receiving a data control service;
sending the data control service;
measuring a downlink reference signal;
sending an uplink reference signal; or
performing a layer 1 measurement.

5. The method according to claim 1, wherein simultaneously measuring the signals from the different satellite networks comprises an intra-frequency measurement of the signals from the different satellite networks and an inter-frequency measurement of the signals from the different satellite networks.

6. The method according to claim 5, wherein the inter-frequency measurement is an inter-frequency measurement without a measurement gap.

7. The method according to claim 1, wherein the different satellite networks comprise at least one of a geo-stationary satellite network or a non-geo-stationary satellite network.

8. A method for transmitting information, performed by a network device, comprising:
receiving indication information from a user equipment, the indication information being configured to indicate whether the user equipment supports a capability of simultaneously measuring signals from different satellite networks.

9. The method according to claim 8, further comprising:
in response to the indication information indicating that the user equipment supports the capability of simultaneously measuring the signals from the different satellite networks performing network device scheduling within a servicing cell of the user equipment during a neighbouring cell measurement performed by the user equipment,
wherein the servicing cell corresponds to a first satellite network, the neighbouring cell corresponds to a second satellite network, and the first satellite network is different from the second satellite network.

10. The method according to claim 8, further comprising:
in response to the indication information indicating that the user equipment does not support the capability of simultaneously measuring the signals from the different satellite networks, stopping network device scheduling within a servicing cell of the user equipment for a set time period,
wherein the servicing cell corresponds to a first satellite network, the neighbouring cell corresponds to a second satellite network, and the first satellite network is different from the second satellite network, and
wherein the set time period comprises a time period for the user equipment performing the neighbouring cell measurement.

11. The method according to claim 9, wherein the network device scheduling comprises at least one of:
receiving a data control service;
sending the data control service;
receiving an uplink reference signal; or
sending a downlink reference signal.

12. The method according to claim 8, wherein simultaneously measuring the signals from the different satellite networks comprises an intra-frequency measurement of the signals from the different satellite networks and an inter-frequency measurement of the signals from the different satellite networks.

13. The method according to claim 12, wherein the inter-frequency measurement is an inter-frequency measurement without a measurement gap.

14. The method according to claim 8, wherein the different satellite networks comprise at least one of a geo-stationary satellite network or a non-geo-stationary satellite network.

15-19. (canceled)

20. A user equipment, comprising a processor and a memory having instructions stored thereon that when being executed by the processor, cause the user equipment to implement actions comprising:
sending indication information to a network device, the indication information being configured to indicate whether the user equipment supports a capability of simultaneously measuring signals from different satellite networks.

21. The user equipment according to claim 20, wherein the actions further comprise:
in response to the indication information indicating that the user equipment supports the capability of simultaneously measuring the signals from the different satellite networks, performing user equipment scheduling within a servicing cell during a neighbouring cell measurement performed by the user equipment,
wherein the servicing cell corresponds to a first satellite network, the neighbouring cell corresponds to a second satellite network, and the first satellite network is different from the second satellite network.

22. The user equipment according to claim 20, wherein the actions further comprise:
in response to the indication information indicating that the user equipment does not support the capability of simultaneously measuring the signals from the different satellite networks, stopping user equipment scheduling within a servicing cell for a set time period,
wherein the servicing cell corresponds to a first satellite network, the neighbouring cell corresponds to a second satellite network, and the first satellite network is different from the second satellite network, and
wherein the set time period comprises a time period for the user equipment performing the neighbouring cell measurement.

23. The user equipment according to claim 21, wherein the user equipment scheduling comprises at least one of
receiving a data control service;
sending the data control service;
measuring a downlink reference signal;
sending an uplink reference signal; or
performing a layer 1 measurement.

24. The user equipment according to claim 20, wherein simultaneously measuring the signals from the different satellite networks comprises an intra-frequency measurement of the signals from the different satellite networks and an inter-frequency measurement of the signals from the different satellite networks.

25. The user equipment according to claim 24, wherein the inter-frequency measurement is an inter-frequency measurement without a measurement gap.
